(19) United States
(12) Patent Application Publication
(10) Pub. No.: US 2004/0029762 A1
(43) Pub. Date: Feb. 12, 2004

(54) Dry, solid, thin, non-elastic, frangible surfactant sheet

(76) Inventor: Charles Hensley, Long Beach, CA (US)

Correspondence Address: TOD R. NISSLE, P.C., P.O. Box 55630, Phoenix, AZ, 85078, US

(21) Appl. No.: 10/217,314

(22) Filed: Aug. 9, 2002

(51) Int. Cl. C11D 17/00

(52) U.S. Cl. 510/438

(57) ABSTRACT

A dry, solid, thin, non-elastic, frangible surfactant sheet is provided for cleansing non-living epithelial cells. The sheet, when applied to non-living keratin-filled cells on the epidermis, is readily broken and combines with water to form a soap formulation for cleansing the skin.

This invention relates to soap compositions.

More particularly, the invention relates to frangible soap compositions for cleansing keratin filled epithelial cells.

The following terms used herein have the meanings set forth below.

Absorb. To swallow up, suck up by capillary, osmotic, solvent or chemical action.

Adsorb. To take up by physical or chemical forces of molecules of gas, of dissolved substances, or of liquids or by the surfaces of solids or liquids with which they are in contact.

Break. To separate.

Colloid. A substance that (a) apparently is dissolved, but diffuses slowly through a membrane; or (b) is in a fine state of subdivision so particles are too small to be visible in an ordinary optical microscope and do not settle, or settle slowly.

Dispersion. An emulsion or suspension. Comprises the dispersed substance and the medium it is dispersed in.

Dry. A substance is dry if it feels dry to the touch. Many substances that feel dry include water in their composition. The fact that a composition includes water or another liquid does not necessarily mean the composition is not dry. For example, chewing gum usually includes water or another liquid but is considered dry because it is dry to the touch. An apple includes water, but is—unless there is water on the surface of the apple because it has just been washed—dry to the touch. A wet sponge is not dry to the touch. A damp paper towel is not dry to the touch. Water is not dry.

Elastic. An object is elastic if the object, after forces are applied once to the object in the manner indicated by arrows A and B in FIG. 7 to stretch the object an amount greater than at least 5% of its length (i.e., if the object is stretched so its length is at least 105% of its original length) and the forces A and B are then discontinued, returns within ten seconds to within 1% of its original length.

Emulsion. Intimate mixture of two incompletely miscible liquids.

Epithelium. Cellular animal tissue that covers a free surface and consists of one or more layers of cells forming a sheet practically unbroken by intercellular substance and smoothly extended (as in epidermis) and that serves especially to enclose and protect the other parts of the body, to form the most essential part of the tactile touch organs, to produce secretions and excretions, and to function in assimilation.

Hydrophilic. Strong affinity for water.

Hydrophobic. Weak affinity for water.

Integral. As used in connection with a chemical composition in a soap sheet, means the chemical composition coats, impregnates, absorbed in the sheet, is adsorbed in the sheet, or is dispersed throughout the sheet. One way the chemical composition is dispersed throughout the sheet is to admix the components comprising the sheet with the chemical composition and then forming the sheet with the chemical composition dispersed throughout the sheet.

Lipophilic. Strong affinity for fats or other lipids.

Miscible. Capable of mixing without separation of the two phases. The mixture formed by a miscible liquid or solid can be a solution or a dispersion (emulsion or suspension).

Non-planar surface. A surface bent along more than one axis. A flat sheet of paper bent into a U-shape is considered planar because the paper, through curved, is bent along only one axis. The parallel front and back surfaces of sheet 30 in FIG. 6 are considered planar. The parallel front and back surfaces of sheet 31 in FIG. 8 are bent around more than one axis and are considered non-planar. Most of the outer skin surface of an individual's body is considered non-planar because the surface is arcuate and is bent or contoured around two or more axes.

Oleophilic. Strong affinity for oils.

Organic. Being, containing, or relating to carbon compounds, especially in which hydrogen is attached to carbon whether derived from living organisms or not.

Organic solvent. A solvent including a carbon compound. Examples include, without limitation, glycerin, PEG-6 (Polyethylene glycol 300), and Mpdiol glycol.

Silicone. An organic siloxane, especially any of a large group of polymerized organic siloxanes that are unusually stable over a wide temperature range, that are obtained as oily fluids, resins and elastomers convertible into greases and other compounds, coatings, and rubbers, and that are used chiefly in waterproofing, lubrication, and electric insulation.

Silicone derivative. A silicone with one or more attributes beneficial to skin. Such attributes include emolliency, moisturization, skin smoothing, wrinkle reduction, skin softening, etc. Examples of silicone derivations, include, without limitation, most organosilicones, organic siloxanes, and their cross polymer (e.g., dimethicone, dimethicone copolyol, cetyl dimethicone copolymer, cetyl dimethicone, stearyl dimethicone, stearoxydimethicone, behenoxydimethicone, alkyl methicone, amodimethicone, dimethicone alkyl detaine, cyclomethicone, polydimethylsiloxane, diphenyldimethyl polysiloxane, silicone elastomers, cyclomethicone and dimethicone crosspolymer, Jeesilc 6056, Dow Corning 2501).

Solution. A solid, liquid, or gas mixed homogeneously with a liquid.

Solid. A substance that under ordinary conditions retains a definite size and shape, that has a definite capacity for resisting forces (as compression, tension, strain) which tend to deform it, and that has the three dimensions length, breadth and thickness. A solid can be pliable, like a thin sheet of steel, and can be porous, like a sponge.

Solvent. A substance capable of or used in dissolving or dispersing one or more other substances, especially a liquid component of a solution present in greater amount than the solute.

Surfactant. In general, a surfactant is a substance useful for its cleansing, wetting, dispersing, or similar powers. Each of such functions are performed by a surfactant due to its ability to reduce surface tension. More specifically, as used herein, a surfactant is an ingredient that reduces the surface tension of water. Examples of surfactants include, without limitation, Tauranol 1-78-6, Tauranol ws conc., Lathanol LAL, Dow Corning 2501, Hydramol PGDS.

Suspension. Particles mixed in a fluid or a solid, but undissolved.

Water miscible organic solvent. An organic solvent that can be mixed with water. In the practice of the invention, the preferred (but not required) water miscible organic solvents are those commonly used in cosmetic applications, for example, glycerin, ethylene glycol, propylene glycol, butylene glycol, hexylene glycol, pyrrolidone, N-methyl pyrrolidone, dimethyl sulfoxide, dimethyl sulfone, polyethylene glycol, polypropylene glycol, methylpropanediol, and similar solvents.

Various soap compositions are known. Many such compositions, though long used, are somewhat awkward to use or carry. For example, bar soap ordinarily must, after being wetted and used, be put in a soap dish or container. When the bar soap is put in the soap dish or container, soap suds typically drip onto the counter top adjacent the container and soap from the bar adheres to the container, wasting soap.

Towels containing soap are available, but must be disposed of after use and are relatively expensive because of the additional cost of manufacturing the towel containing the soap.

Dispenser bottles containing liquid or gel soap are widely used, but such bottles are awkward to carry during travel. These containers also tend to be messy because some of the soap spills or leaks on the container, in a suitcase, or the counter top adjacent the container. Such spills are particularly in evidence in the restrooms in commercial establishments where liquid soap has leaked from dispensers onto counter tops.

Containers of soap powder are available. Such container are also awkward to transport while traveling. The solid powder can abrade and be irritating to a user's hands.

One reason conventional soaps or soap containers are bulky is that the concentration of soap composition in the containers is relatively small in comparison to the carrier in which the soap composition is dispersed. This requires an individual to use larger portions of the soap in order to wash. When larger portions are used, an individual must buy soap more frequently.

Accordingly, it would be highly desirable to provide a soap composition that would greatly reduce, or eliminate, spills and mess commonly associated with using soap, that would be readily transported, and that would not require bulky containers.

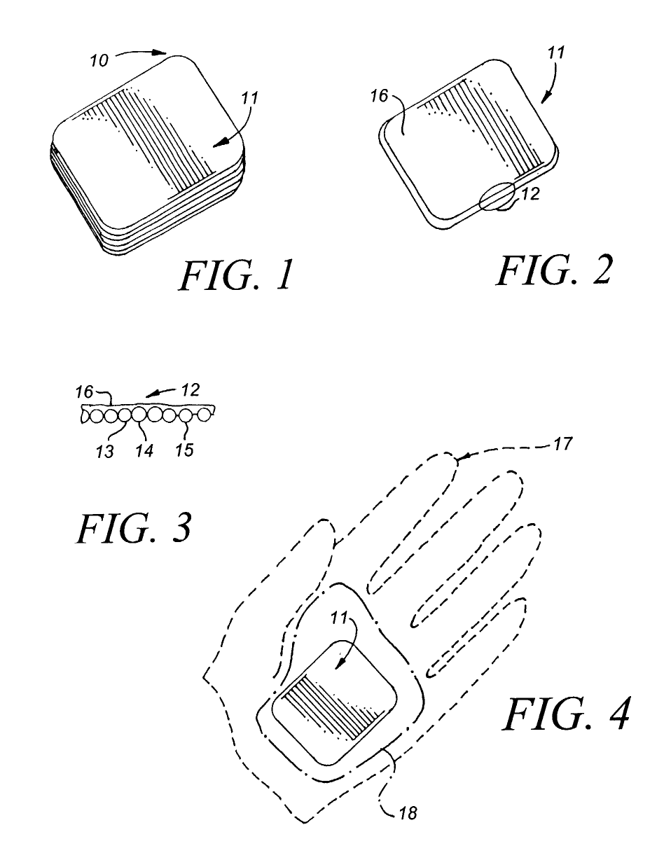

I have discovered an improved soap formulation 11. The formulation comprises a dry, sold, thin, non-elastic frangible sheet comprised of at least one water miscible material. The sheet is preferably, but not necessarily, sized to fit in the palm area 18 of the hand 17 of an individual. The soap formulation 11 can be in packages containing a stack 10 of the formulation 11 (FIG. 1) or can be in packages containing only a single soap formulation 11 (FIG. 2). The packaging can comprise plastic bags, paper containers, plastic containers, elastic bands, or any other desired packaging materials. The soap formulation includes at least one surfactant integral to the sheet. The frangible sheet can also include a dispersion integral to the sheet. The dispersion includes at least one water-soluble or water-dispersible polymer; at least one water-soluble material or water-dispersible material comprising vitamin C; water; and, at least one surface active agent. The frangible sheet can can also include, either in combination with a surfactant or not in combination with a surfactant, one or more other ingredients which may or may not be water soluble or water dispersible ingredients. Such ingredients include, by way of example and not limitation other vitamins, anti-inflammatory agents, anesthetics, analgesics, enzymes, UV-absorbers, antiperspirants, deodorants, colorants, hydroxy aids, skin lightening agents, emollients, medications, antibiotics, antifungal agents, and insect repellents. If desired, such ingredients need not be water soluble or water dispersible. The surfactant or other compositions preferably, but not necessarily, are incorporated in the sheet comprising the soap formulation such that the sheet remains dry, sold, thin, non-elastic, and frangible.

The soap formulation is used by placing it against a non-planar skin surface, by breaking the formulation into pieces, and by moving the pieces over the skin surface with water to produce an aqueous soap formulation to wash the skin surface. The soap formulation is utilized on dead, squamous, keratin filled outer epithelial skin cells. This is important because the surfactants and other chemical components comprising soap are not ordinarily put in an individual's mouth or eyes or in contact with the soft living tissue and membranes found in the mouth and eyes. Putting soap in contact with such living tissues is, at the least, irritating, and can, at the worst, cause significant injury. On the other hand, contacting dead outer epithelial skin cells with the soap formulations of the inventions ordinarily effectively cleanses the skin surface while causing little or no damage to the epidermis. Similarly, when the frangible soap sheets of the invention are broken into pieces, such pieces are much less likely to cut or otherwise injure dead keratin filled outer epithelial cells than living tissue. The keratin in non-living outer epithelial cells helps make the cells tough and waterproof. The non-living squamous outer epithelial cells engage and help to break apart the soap formulation. In contrast, if the soap formulation of the invention is rubbed against living tissue, the liquid in the living tissue normally facilitates the soap formulation sliding over the living tissue and does not tend to facilitate the breakup of the soap formulation. Even when dead outer epithelial cells are wetted, the scaly nature of the cells continues to facilitate the breakup of frangible sheets used in the soap formulation. It is critical in the practice of the invention to break up the soap formulation of the invention into pieces. This facilitates dissolution of the soap formulation and facilitates being able to completely dispose of the soap formulation by rinsing the skin and washing the formulation in its entirety down a sink drain. Consequently, the invention is not intend for use on living tissue, but only for use on the outermost layer of the epidermis comprised of dead epithelial cells.

In the practice of the invention it is important that the soap formulation be frangible and separable into a plurality of pieces, especially when the formulation is contacted by a non-planar surface comprising the palm of the hand or another external skin surface comprised of dead squamous epithelial cells. This breaking of the soap formulation increases the surface area of the formulation and facilitates the cleansing action of the formulation. Breaking of the soap formulation also facilitates washing the entire formulation down the drain of a sink so that little or no clean up is involved after the formulation has been utilized.

Although not necessary, it is preferred that the formulation be non-elastic. Elastic substances typically include long chain polymers that do not readily break.

The material or materials used to make the dry, solid, thin, non-elastic, frangible sheet are preferably, but not necessarily, water miscible because this also facilitates the use of water in cleansing the skin.

While the thickness of the sheet used to make the soap formulation can vary as desired, it is preferable that the sheet be thin with a thickness of less than two millimeters, preferably less than about one millimeter, most preferably less than about 0.10 mm. A thin sheet is more readily broken into pieces, and, typically is more readily broken into small pieces that increase the surface area of the formulation and facilitate complete consumption of the formulation and facilitate washing the complete formulation down the drain of a sink.

Any desired material can be utilized to fabricate the dry, solid, thin, non-elastic, frangible sheet. By way of example, and not limitation, small plastic beads can be utilized and held together by coating the beads with a soap composition to form a dry, solid, thing, non-elastic, frangible sheet; rice paper can comprise the dry, solid, thin, non-elastic, frangible sheet; a wafer or other substrate can comprise the dry, solid, thin, non-elastic, frangible sheet, etc. The material utilized to make the sheet is preferably water miscible. The amount of the water miscible material or other materials utilized to fabricate the solid frangible sheet is from 20% to 99.9%, preferably 50% to 99.9% by weight.

The surfactant (or other chemical component) used in combination with the sheet can be integrally formed in the sheet by coating the sheet, by impregnating the sheet with the surfactant, by admixing the surfactant with material used to form the sheet, etc.

The amount of surfactant in the soap formulation is 0.1% to 40% by weight. The surfactant is preferably hydrophilic and absorbs a portion of water. The water absorption characteristic of the surfactant is important in the practice of the invention because when water is bound with a hydrophilic or water-absorbing ingredient, the pH of the formulation ordinarily is not that important with respect to the stability of vitamin C and other components.

Examples of surfactants that can be utilized are anionic, amphoteric, nonionic and cationic surfactants. Examples of anionic zwitterionic surfactants include, without limitation, soaps, alkyl sulfates, anionic acyl sarcoinates, methyl acyl taurantes, N-acyl glutamates, acyl isethionates, alkyl phosphate esters, ethoxylated alkyl phosphate esters, alkyl sulfosuccinates, trideceth sulfates, protein condensates, mixtures of ethoxylated alkyl sulfates, and the like.

Examples of anionic non-soap surfactants are, without limitation, the alkali metal salts of organic sulfate having in their molecular structure an alkyl radical containing from about 8 to about 22 carbon atoms and a sulfonic acid or sulfuric acid ester radical.

Examples of Zwitterionic surfactants are, without limitation, derivatives of aliphatic quaternary ammonium, phosphonium, and sulfonium compounds, in which the aliphatic radicals can be straight chain or branched and wherein one of the aliphatic substitutents contains from about 8 to 18 carbon atoms and one contains an anionic water-solubilizing group, e.g, carboxy, sulfonate, sulfate, phosphate, or phosphonate.

Examples of amphoteric surfactants are, without limitation, derivatives of aliphatic secondary and tertiary amines in which the aliphatic radical can be straight chain or branched and wherein one of the aliphatic substituents contains from about 8 to about 18 carbon atoms and one contains an anionic water solubilizing group, e.g., carboxy, sulfonate, sulfate, phosphate, or phosphonate.

Examples of cationic surfactants are, without limitation, stearyidimenthylbenzyl ammonium chloride; dodecyltrimethyl ammonium chloride; nonylbenzylethyidimethyl ammonium nitrate; and tetradecylpyridinium bromide.

Nonionic surfactants include, without limitation, compounds produced by the condensation of alkylene oxide groups (hydrophilic in nature) with an organic hydrophobic compound, which may be aliphatic or alkyl aromatic in nature, for example, the polyethylene oxide condensates of alkyl phenols.

If desired, from 1% to 30%, preferably 1% to 10%, by weight of silicone derivatives can be included in the soap formulation of the invention. As noted above, a silicone derivative is a silicone with one or more attributes beneficial to skin. Such attributes include emolliency, moisturization, skin smoothing, wrinkle reduction, skin softening, etc. Consequently, silicone derivatives often are desirable in the soap formulation of the invention. Silicones also can enhance the stability of vitamin C in the soap formulation.

When a vitamin C dispersion is utilized in the soap formulation of the invention, the dispersion can be produced by forming first solution is formed of ascorbic acid, water, and a water soluble or water dispersible polymer, by mixing the first solution with a second solution of a surfactant and oil, by homogenizing the first solution and the second solution to form a mixture of the first solution and the second solution, and, by cooling the mixture, solidifying the first solution to form particles dispersed in the oil. The homogenization is done at a temperature above 40 degrees C., preferably above 50 degrees C. Particles removed from the resulting dispersion are coated with oil. The oil tends to retard the degradation of the ascorbic acid. Such oil coated particles be used to coat a thin frangible water miscible sheet formed in accordance with the invention. The water-soluble or water-dispersible polymers may comprise any natural or synthetic polymer. For example methacrylates such as polymers having units derived from acrylic acid, acrylamide, methacrylic acid, sodium polyacrylate and copolymers thereof, cellulosic polymers, polyehtylene glycols and copolymers thereof, natural or modified natural resisns, polyvinyl resins, water-solubilized or water-dispersible polyurethanes, water-solubilized or water-dispersible ethers, plyethylenimines, block copolymers, and graft copolymers. The water-soluble or water-dispersible materials may be single materials or combinations thereof. The amount of vitamin C in the dispersion is in the range of 5% to 75% by weight.

The following examples are presented by way of illustration, and not limitation, of the invention. In each example, the amount or proportion of each ingredient is in weight percent unless otherwise indicated.

### EXAMPLE I

A tray sixty millimeters long and fifty millimeters wide is obtained and set on a flat horizontal surface. The tray is substantially filled with a single layer of generally spherical biodegradable plastic beads. Each bead has a diameter of about one millimeter. Some of the beads 13, 14 (FIG. 3) touch adjacent beads. Other beads 15 are spaced a short distance apart from adjacent beads. A soap solution or slurry is sprayed or otherwise applied to the top of the beads. The soap solution dries to form a hard solid layer 16 that extends over and holds together the plastic beads to form a dry, solid, thin, non-elastic, frangible sheet comprising a soap formulation 11. The layer 16 performs the dual function of comprising part of the sheet structure and of including the surfactant. The soap formulation 11 is not pliable. Formulation 11 is placed in the palm 18 of an individual against dead squamous epithelial cells. The individual presses his other hand against formulation 11 to break frangible formulation 11 in a plurality of pieces of the type illustrated in FIG. 9. Each piece includes one or more beads 13 to 15 and a portion 16A, 16B, of the soap layer 16. Water is, if not already present, added to the pieces of FIG. 9 and the hands are rubbed together to move said pieces over the skin surface with the water to produce an aqueous soap formulation to wash the skin surface.

### EXAMPLE II

Example I is repeated, wherein the soap solution is prepared as follows. Similar results are obtained.

The following ingredients are provided to prepare the soap solution.

| Ingredient | Weight Percent |
|---|---|
| Glycerin (water miscible organic solvent) | 48.300 |
| Methyl paraben | 0.200 |
| Phenoxyethanol | 0.900 |
| Tauranol I-78-6 (surfactant) | 20.000 |
| Tauranol ws conc. (surfactant) | 5.000 |
| Fragrance | 0.500 |
| FDC Yellow #6 | qs |

All of the ingredients, with the exception of the colorant (FDC Yellow #6), are mixed to form a composition. The mixture is heated and stirred at 60 to 70 degrees C. until the mixture is homogenous, i.e., for about five to ten minutes. The homogeneous mixture is cooled to room temperature. The colorants are admixed in the homogenous mixture. If the soap solution does not dry or solidify quickly enough when sprayed or applied to the beads, a gum or other thickener can be added to the mixture.

### EXAMPLE III

A dry, solid, thin, non-elastic, frangible sheet is provided comprising a piece of rice paper that is ten millimeters wide and twenty millimeters long. A surfactant is sprayed on the rice paper and allowed to dry. The resulting soap formulation is placed in the wetted palm 18 of an individual against dead keratin filled epithelial cells. The individual presses his other hand against the soap formulation and moves the hands over one another to break the frangible soap formulation into a plurality of pieces and produce an aqueous soap formulation to wash the skin surface.

### EXAMPLE IV

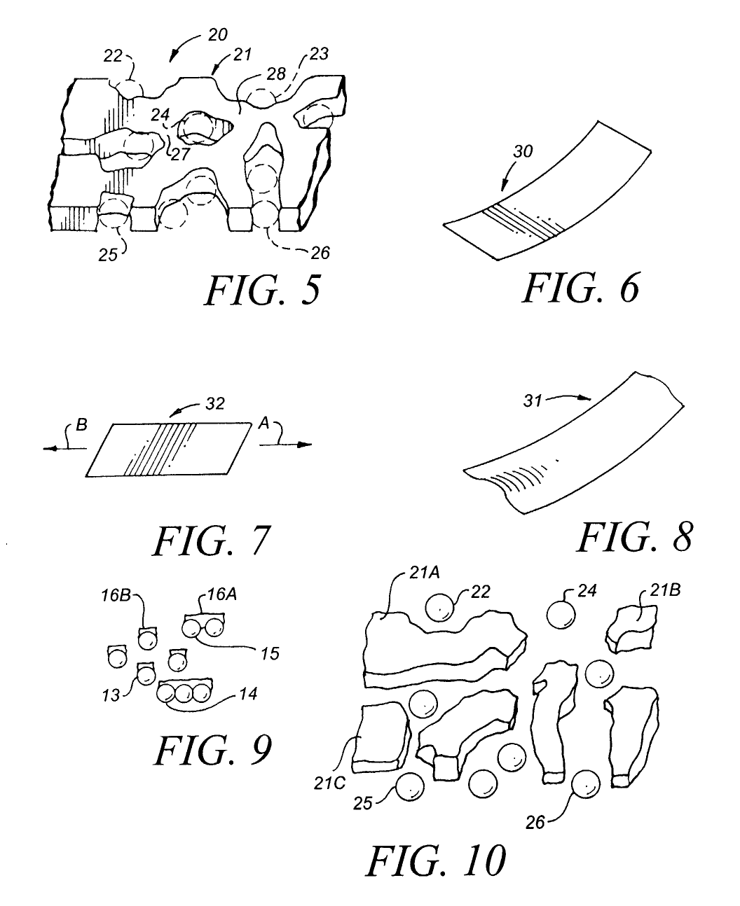

A dry, solid, thin, non-elastic, frangible sheet is provided comprising a pliable sheet of starch paper 21 (FIG. 5) that is twenty millimeters wide and thirty millimeters long. Sheet 21 is readily broken by tearing. A water miscible surfactant powder is applied to the starch paper 21. Surfactant powder particles 22, 23, 24, 25, 26 fill pores in paper 21 and coat and impregnate paper 21. The sheet 21 and powder particles 22 to 26 comprise a soap formulation 20. The soap formulation 20 is placed in the wetted palm 18 of an individual against dead epithelial cells. The individual presses his other hand against formulation 20 and moves the hands over one another to wet and break frangible formulation 20. The ridges on the skin in the palm facilitate breakage of formulation 20. The water facilitates the breaking of formulation 20 by solubilizing sheet 21, particularly the smaller, narrower bridge portions 27, 28 of sheet 21. Breaking sheet 21 releases particles 22 to 26 from the sheet. Rubbing the hands together moves the pieces and particles over the skin surface with the water to produce an aqueous soap formulation to wash the skin surface.

### EXAMPLE V

A first solution is prepared comprising six grams of a long-chain fatty acid monoester of sorbitan monostearate, a polyhydric alcohol and surfactant and forty grams of mineral oil. The solution is heated to fifty-five degrees C. Twenty grams of polyethylene glycol is dissolved in twenty grams of deionized water. The water is stirred and heated to sixty degrees C., after which fifteen grams of L-ascorbic acid is dissolved in the solution. Once the ascorbic acid is dissolved, the water is mixed with the mineral oil—alcohol to form a homogeneous mixture. The dispersion is cooled to room temperature. At room temperature, the dispersion includes small particles comprised of the polymer, ascorbic acid, and water. A dry, solid, thin, non-elastic, frangible sheet of rice paper twenty millimeters long and twenty millimeters wide is provided. Particles are removed from the dispersion, placed on the rice paper, and allowed to dry. A surfactant solution is sprayed on the sheet of rice paper and on the dispersion particles on the sheet of rice paper. The surfactant solution is allowed to dry. This produces a soap formulation including the sheet of rice paper, dispersion particles, and surfactant.

### EXAMPLE VI

Example ! Is repeated except that the soap formulation does not require the addition of water after the formulation is broken into pieces. Instead, after the soap formulation is broken into a plurality of pieces, moving the hands over one another moves the pieces over the skin and caused the pieces to abrade, absorb, adsorb, and/or otherwise remove dirt and grease or other desired components from the skin to cleanse the skin. In one preferred embodiment, the soap formulation is broken into a fine particulate or powder that seems to disappear as the hands are rubbed together, or, as the soap formulation is rubbed over an area of skin other than the hands. The powder dissipates or spreads over an area of skin and is not readily discernible to the casual observer.

The dry, solid, thin, non-elastic frangible sheet used in the practice of the invention can be formed from polymer beads or particles (likely in combination with a binding material to hold the particles together, although the particles could be heated sufficiently to cause them to fuse slightly together so the “fusion bond” could be readily broken), from silica particles (likely with a binder to hold the particles together), from plastic, from starch, from a polysaccharide, or from any other desired material. The sheet can, if desired, be brittle. When a surfactant or other chemical composition is applied to the sheet (by coating, impregnating, etc. the sheet) or is incorporated in or dispersed throughout the sheet (by, for example, mixing the composition with the ingredients used to make the sheet prior to producing the sheet), the resulting formulation is still preferably—but not necessarily—dry, solid, thin, non-elastic and frangible.

Having described the presently preferred embodiments and best mode of the invention in such terms as to enable those of skill in the art to understand and practice the invention, I claim:

1. A frangible soap formulation for cleansing the non-living squamous keratin-filled epithelial integument of an animal, comprising
(a) a solid thin non-elastic frangible sheet comprised of at least one water miscible material;
(b) at least one surfactant integral to said sheet; and,
(c) a dispersion integral to said sheet and including
(i) at least one water-soluble or water-dispersible polymer,
(ii) at least one water-soluble material or water-dispersible material comprising vitamin C,
(iii) water, and
(iv) at least one surface active agent.

2. A method for washing the non-living squamous keratin-filled epithelial integument of an animal, comprising the steps of
(a) providing a soap composition comprising
(i) a solid, thin, non-elastic, frangible sheet, and
(ii) at least one surfactant integral to said sheet;
(b) placing said soap composition against a non-planar skin surface comprised of dead keratin-filled epithelial cells;
(c) breaking said soap composition into a plurality of pieces; and,
(d) moving said pieces over said non-planar skin surface to cleanse said skin surface.

3. A method for making a soap formulation for cleansing the non-living squamous keratin-filled epithelial integument of an animal, comprising the steps of:
(a) providing a solid thin non-elastic frangible sheet comprised of at least one water miscible material; and,
(b) impregnating said sheet with at last one surfactant.

4. A method for making a soap sheet for cleansing the non-living squamous keratin-filled epithelial integument of an animal, comprising the steps of
(a) providing a solid, thin, non-elastic frangible sheet comprised of at least one water miscible material; and,
(b) coating said sheet with at least one surfactant.

5. A frangible soap formulation for cleansing the non-living squamous keratin-filled epithelial integument of an animal, comprising
(a) a solid thin non-elastic frangible sheet comprised of at least one water miscible material, said sheet being
(i) solid,
(ii) thin,
(iii) non-elastic, and
(iv) frangible; and,
(b) at least one surfactant integral to said sheet.

6. A method for making a soap sheet for cleansing the non-living squamous keratin-filled epithelial integument of an animal, comprising the steps of
(a) providing at least one water miscible carrier;
(b) providing at least one surfactant;
(c) a liquid;
(d) combining said carrier, surfactant, and liquid to produce a forming composition; and,
(e) making a dry, solid, thin, non-elastic frangible sheet of said forming composition.

7. A method for making a soap sheet for cleansing the non-living squamous kertain-filled epithelial integument of an animal, comprising the steps of
(a) providing at least one water miscible carrier;
(b) providing at least one surfactant;
(c) providing at least one water-soluble material or water-dispersible material comprising vitamin C;
(d) combining said carrier, surfactant, and liquid to produce a forming composition; and,
(e) making a dry, solid, thin, non-elastic frangible sheet of said forming composition.
